(19) United States
(12) Patent Application Publication
(10) Pub. No.: US 2007/0097873 A1
(43) Pub. Date: May 3, 2007

(54) MULTIPLE MODEL ESTIMATION IN MOBILE AD-HOC NETWORKS

(75) Inventors: Yunqian Ma, Roseville, MN (US); Karen Z. Haigh, Greenfield, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/163,806

(22) Filed: Oct. 31, 2005

(51) Int. Cl. H04J 1/16

(52) U.S. Cl. 370/252

(57) ABSTRACT

The present invention, in illustrative embodiments, includes methods and devices for operation of a MANET system. In an illustrative embodiment, a method includes steps of analyzing and predicting performance of a MANET node by the use of a multiple model estimation technique. Another illustrative embodiment optimizes operation of a MANET node by the use of a model developed using a multiple model estimation technique. An illustrative device makes use of a multiple model estimation technique to estimate its own performance. In a further embodiment, the illustrative device may optimize its own performance by the use of a model developed using a multiple model estimation technique.

### FIELD

The present invention is related to the field of wireless communication. More specifically, the present invention relates to modeling operations within an ad-hoc network.

### BACKGROUND

Mobile ad-hoc networks (MANET) are intended to operate in highly dynamic environments whose characteristics are hard to predict a priori. Typically, the nodes in the network are configured by a human expert and remain static throughout a mission. This limits the ability of the network and its individual devices to respond to changing physical and network environments. Providing a model of operation can be one step towards building not only improved static solutions/configurations, but also toward finding viable dynamic solutions or configurations.

### SUMMARY

The present invention, in illustrative embodiments, includes methods and devices for operation of a MANET system. In an illustrative embodiment, a method includes steps of analyzing and predicting performance of a MANET node by the use of a multiple model estimation technique, which is further explained below. Another illustrative embodiment optimizes operation of a MANET node by the use of a model developed using a multiple model estimation technique. An illustrative device makes use of a multiple model estimation technique to estimate its own performance. In a further embodiment, the illustrative device may optimize its own performance by the use of a model developed using a multiple model estimation technique.

### BRIEF DESCRIPTION OF THE FIGURES

FIG. 1A is an illustration of a mobile ad-hoc network;

FIG. 1B illustrates, in block form, a node for the network of FIG. 1A;

FIG. 2A is a block diagram for building a model by the use of a learning method;

FIG. 2B illustrates, in a simplified form, throughput as a function of inputs for a wireless communication device;

FIG. 3 illustrates a mapping of system observables onto performance results;

FIG. 4A shows an attempt at regression on a data set;

FIG. 4B shows multiple model regression for the data set of FIG. 4A;

FIG. 4C shows multiple model regression for another data set;

FIG. 4D shows a complex single model regression;

FIG. 5 illustrates a weighted multiple model regression;

FIG. 6 shows a complex weighted, multiple model regression;

FIGS. 7A-7B illustrate observation of a new data point and updating of a multiple model regression in light of a plurality of data points;

FIG. 8 shows in block form an illustrative method;

FIGS. 9A-9B show in block form another illustrative method;

FIG. 10 shows in block form yet another illustrative method; and

FIG. 11 shows another illustrative embodiment in which a first device indicates an operating parameter to second device.

### DETAILED DESCRIPTION

The following detailed description should be read with reference to the drawings. The drawings, which are not necessarily to scale, depict illustrative embodiments, and are not intended to limit the scope of the invention.

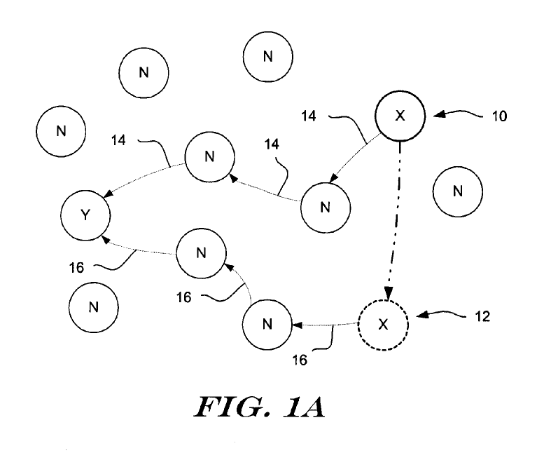

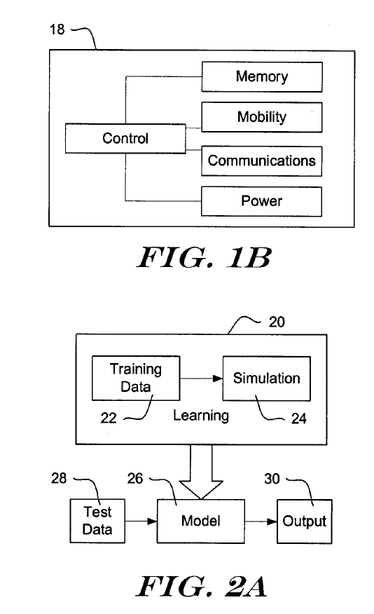

FIG. 1A is an illustration of a MANET system. The network is shown having a number of nodes N, X, Y. In a MANET system, a message sent by X may reach Y by “hopping” through other nodes N. This data transmission form is used at least in part because device X has a limited transmission range, and intermediate nodes are needed to reach the destination. The network may include one or more mobile devices, for example, device X is shown moving from a first location 10 to a second location 12. As device X moves, it is no longer closest to the nodes that were part of the initial path 14 from X to Y. As a result, the MANET system directs a message from X to Y along a different path 16.

A gateway or base node may be provided for the MANET system as well. For example, a MANET system may comprise a number of mobile robots used to enter a battlefield and provide a sensor network within the field. The mobile robots would be represented by nodes such as node X, which send data back to a base node, such as node Y, via other mobile robots. While different nodes may have different functionality from one another, it is expected that in some applications, several nodes will operate as routers and as end hosts.

Narrowing the view from the network to the individual device, a single node is shown in FIG. 1B. The individual node 18 may include, physically, the elements shown, including, a controller, memory, a power supply (often, but not necessarily, a battery), some sort of mobility apparatus, and communications components. Other components may be shown, and not all of these components are required. Using the open-systems-interconnection networking model, there are parameters within each of seven layers that can be used by the node to monitor and/or modify its operation. The plethora of available parameters may include such items as transmission power level, packet size, etc.

For each node, it is possible to capture a great variety of statistics related to node and network operation. Some node statistics may include velocity, packet size, total route requests sent, total route replies sent, total route errors sent, route discovery time, traffic received and sent (possibly in bits/unit time), and delay. Additional statistics may relate to the communications/radio, such as bit errors per packet, utilization, throughput (likely in bits/unit time), packet loss ratio, busy time, and collision status. Local area network statistics may also be kept, for example, including control traffic received and/or sent (both in bits/unit time), dropped data packets, retransmission attempts, etc. These statistics and parameters are merely examples, and are not meant to be limiting. Relative data may be observed as well, for example, a given node may generate a received signal strength indicator (RSSI) for each node with which it is in communication range, and may also receive data from other nodes regarding its RSSI as recorded by those nodes.

For a given node, there are a number of observable factors, which may include past parameters such as power level and packet size that can be controlled by changing a setting of the node. The statistics kept at the node are also considered observables. Anything that can be observed by the node is considered to be an observable. Observables may include parameters that control operation of the network, result from operation of the network, or result from operations within a node, including the above noted statistics and control variables.

Because there are so many observables, it is unlikely that every observable can be monitored simultaneously in a manner that allows improved control. The number of observables that can be monitored is also limited by the likelihood that some MANET devices will be energy constrained devices having limited power output (such as solar powered devices) or limited power capacity (such as battery powered devices). Rather than trying to capture and monitor all observables, one goal of modeling the system from the nodal perspective is to provide an estimate of operation given a reduced set of observables. Such a model may facilitate control decisions that change controllable parameters to improve operation.

It should be understood that “improving” operation may have many meanings, but most likely will mean causing a change to at least one measurable statistic or observable that will achieve, or take a step toward achieving, a desired level of operation. For example, steps that increase data throughput may be considered as improving operation.

FIG. 2A is a block diagram for building a model by the use of a learning method. A learning system may include a learning step, shown at 20. A number of training data 22 are used to perform simulations 24. Various statistical analyses may be performed to generate a model by the use of the training data 22, via simulation. Once built, the model 26 is then tested using test data 28. If the model 26 predicts outcomes from the test data 28 that match those associated with the test data 28, then the model 26 is verified. A match may occur when the model models the data with an amount of error. Rather than simulation, some embodiments instead make use of data collected from a “real” or operating environment of a network, which may be a MANET network.

The illustrative embodiments shown herein are, for illustrative purposes, greatly simplified. Those of skill in the art will understand that extrapolation to a particular number of observables and/or controllables will be a matter of design expertise. For example, it is expected that a well-reduced model for control operation, as measured by node throughput, may show throughput as being a function of more than three or four variables. For example, as shown in FIG. 2B, variables 35A, 35B, out to variable 35N, may each be relevant to the operation of a device X 37, yielding an output 39.

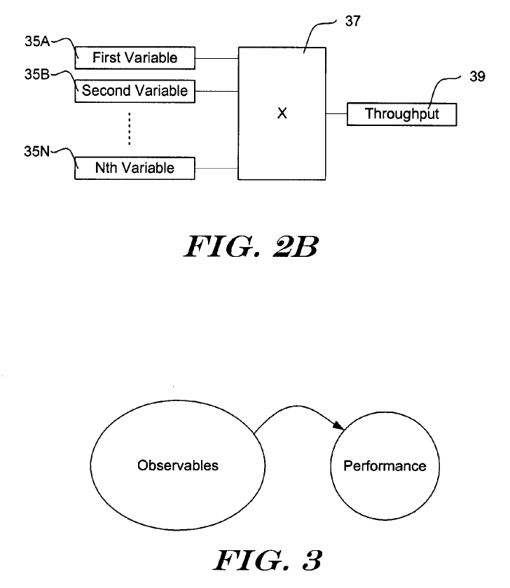

FIG. 3 illustrates a mapping of system observables onto performance results. One aspect of performance for MANET devices is that the environment is quite dynamic, and various aspects of operation can be difficult to predict. Thus, a mapping from the N-dimensional observables onto any given performance metric (single or multi-dimensional) is unlikely to be a one-to-one mapping. Moreover, there may be too many observables to allow each possible observable to be monitored, such that the N-dimensional set of observables may include an M-dimensional set of monitored observables, and a K-dimensioned set of non-monitored observables. As such, it is also possible that the mapping from the M-dimensioned set of monitored observables to a performance metric will not define a function, because a given observable data point, O_{M}, may map to several performance data points, P_{A}, P_{B} . . . , due to the influence of non-observed factors. Since there are unknown and/or unmonitored observables present in the system, direct mapping may be difficult, though it is not necessarily impossible.

Performance may be measured by a number of parameters. For simplicity, performance may be considered herein as a single-dimension result. For example, performance may be a single-node measurement such as data throughput. Alternatively, performance may be a network based measure, for example, a sum of latencies across a network, an average latency, or maximum latency. Indeed, with latency, depending upon the aims of a particular system, there are several formulations for network-wide performance characteristics. Multi-dimensional performance metrics can also be considered, for example, a two-dimensional performance metric may include average node latency and average route length measured in the average number of hops. The present invention is less concerned with the actual performance metric that is to be optimized, and focuses instead on how a performance metric may be modeled as a result of a plurality of inputs.

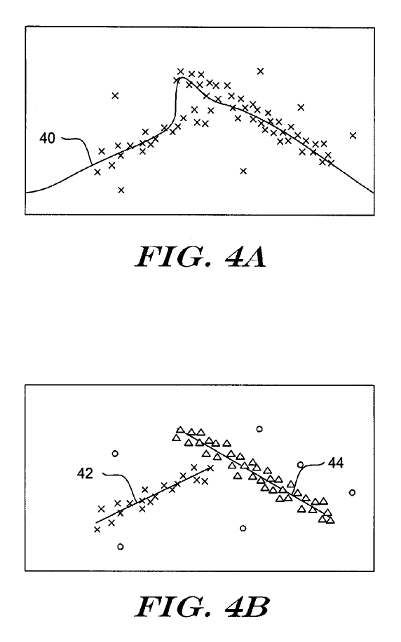

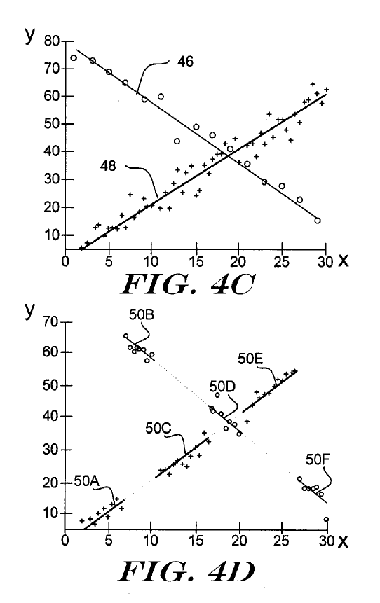

FIG. 4A shows an attempt at regression on a data set. The data set is generally shown in an X-Y configuration, assuming that Y=f(X). A function is created and represented as line 40, but does not correlate to the data particularly well and is rather complex. In contrast, FIG. 4B shows multiple model regression for the same data set of FIG. 4A. In the multiple model regression, two functions result, shown as straight lines 42, 44. The two lines 42, 44 correlate better to the data and are also relatively simple results. The available data may be partitioned among the models. As shown by the Xs in FIG. 4B, some data may correspond to the model represented by line 42, and other data, shown by the triangles, may correspond to the model represented by line 44. It is not necessary that all data be modeled, for example, as shown by the circles, some data is identified as outlier data.

A multiple model regression, in an illustrative example, is achieved by a multi-step process. First, known dimension reducing methods are applied to reduce the number of variables under consideration. Next, a multiple model estimation procedure is undertaken.

In the multiple model estimation procedure, a major model is estimated and applied to the available data. Various modeling techniques (e.g. linear regression, neural networks, support vector machines, etc.) are applied until a model that, relative to the others attempted, describes the largest proportion of the available data, is identified. This is considered the dominant model. Next, the available data is partitioned into two subsets, a first subset being described by the dominant model, and a second subset which is not described by the dominant model. The first subset is then removed from the available data to allow subsequent iterations. The steps of estimating and identifying a dominant model, and partitioning the data, are repeated in iterations until a threshold percentage of the available data is described. For example, iterations may be performed until 95% of the available data has been partitioned and less than 5% of the available data remains.

The use of multiple model regression allows functions to result as shown in FIGS. 4C and 4D. FIG. 4C illustrates a data set in which a first regression 46 and a second regression 48 result. A single function describing both 46 and 48 would poorly correlate to the pattern which, at least in the two dimensions shown, shows two almost orthogonal functions. FIG. 4D illustrates another manner of partitioning, this time with multiple, simple segments 50A-50F. The multiple models and/or segments allow better characterization of the available data by the resulting complex model.

The multiple model regression begins with the assumption that a response value is generated from inputs according to several models. In short:
y=tₘ(x)+δₘ, x∈Xₘ

Where δₘ is a random error or noise having zero mean, and unknown models are represented as target functions tₘ(x), m=1 . . . M. The assumption is that the number of models is small, but generally unkown. Generalizing to a greater number of dimensions, the functions may also be given as:
y=tₘ(wₘ, x)+δₘ, x∈Xₘ

In this case, the wₘ represents the input of a plurality of other parameters. It should be noted that wₘ may represent any and/or all past values of any selected observable value(s). In some instances, wₘ includes one or more previous values for x and y. The use of the x variable in these equations is provided as indicating that, in a given instance, x is the variable that may be adjusted (such as power, packet length, etc.) to predictably cause a change in the parameter, y, that is modeled.

Additional details of the multiple model regression are explained by Cherkassky et al., MULTIPLE MODEL REGRESSION ESTIMATION, IEEE Transactions on Neural Networks, Vol. 16, No. 4, July 2005, which is incorporated herein by reference. The references cited by Cherkassky et al. provide additional explanation, and are also incorporated herein by reference.

Some illustrative embodiments go farther than just finding the model, and move into making control decisions based upon predicted performance from the model. In an illustrative example, given the identified multiple models, a first manner of addressing a control problem is to construct a predictive outcome model. For example, given a state of a MANET device, as described by the observables, the method seeks to improve the performance outcome, y, by modifying x, a controllable parameter. An illustrative method uses a weighted multiple model regression approach. This provides an output from parameters as follows:
y=c₁f₁(w₁, x)+ . . . +cₘfₘ(wₘ, x)

Where the {c₁, . . . cₘ} are the proportions of data, from the training samples or training data, that are described by each of the models fᵢ(wᵢ, x). For example, if there are 100 training samples, and three functions f₁, f₂, f₃ describe 97/100, the above methodology would stop after identifying the three functions f₁, f₂, f₃, since less than 5% of the samples would remain. If 52 of those 97 are described by f₁, then c₁ would be 52/97=0.536; if 31 of those 97 are described by f₂, then c₂ would be 31/97=0.320, and the remaining 14 of 97 are described by f₃, then c₃ would be 14/97=0.144.

By use of this approach, the variable x may be modified to improve function of an individual device or an overall system. A more generalized approach is as follows:
y=c₁f₁(w₁, x₁ . . . xᵢ)+ . . . +cₘfₘ(wₘ, x₁ . . . xᵢ)

In this more general approach, the variables x₁ . . . xᵢ represent a plurality of controllable factors. The predicted outcome y may be a future outcome. Then, an illustrative method includes manipulation of the controllable factors x₁ . . . xᵢ, in light of the observable factors w₁ . . . wₘ, to improve the predicted outcome, y.

FIG. 5 illustrates a weighted multiple model regression. The example shows a first regression model 90, which is treated as the dominant model and, as indicated, comprises 70% of available data samples. A second regression model 92 comprises the other 30% of available data samples. The predictive outcomes, then, are shown along line 94 which combines the predicted outcomes from each of model 90, 92 by using weights associated with each model. Line 94 is characterized by this formula:
y=0.7(f₁(w₁, x))+0.3(f₂(w₂, x))

In some embodiments, the functions f₁ . . . fₘ are selected as simple linear regressions. This can be a beneficial approach insofar as it keeps the functions simple. For example, when performing predictive analysis at the node level, simpler analysis can mean a savings of power. However, the accuracy of the predictive methods may be further improved by adding simple calculations to the weighting factors.

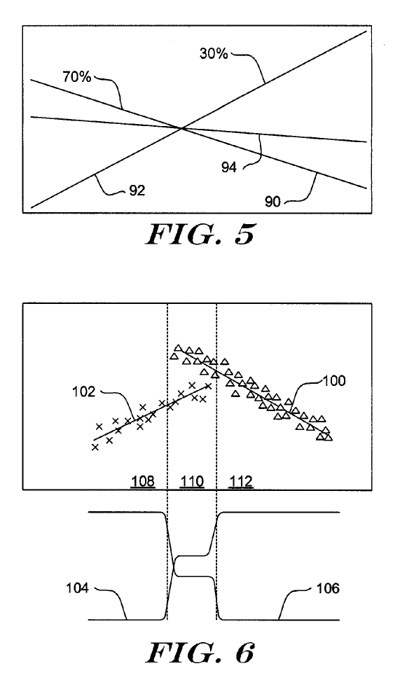

FIG. 6 shows a complex weight multiple model regression. The upper portion of FIG. 6 shows a first function 100 and a second function 102. First function 100 carries a greater weight, as there are more points associated with it than with second function 102. It can be seen that the majority of points for first function 100 are to the right of the majority of points for second function 102.

The lower portion of FIG. 6 illustrates the weight functions used in association with functions 100, 102. Weight 104 is applied to first function 100, while weight 106 is applied to second function 102. There are generally three zones to the weight functions: zone 108, in which the major factor of predictive analysis is second function 102, zone 110 in which both functions 100, 102 are given relative weights, and zone 112 in which the major factor of predictive analysis is first function 100. In this formulation, the resulting formula may take the form of:
y=c₁(x)f₁(w₁, x)+ . . . +cₘ(x)fₘ(wₘ, x)

Generation of the weight formulas, c₁(x) . . . cₘ(x) may be undertaken by any suitable method.

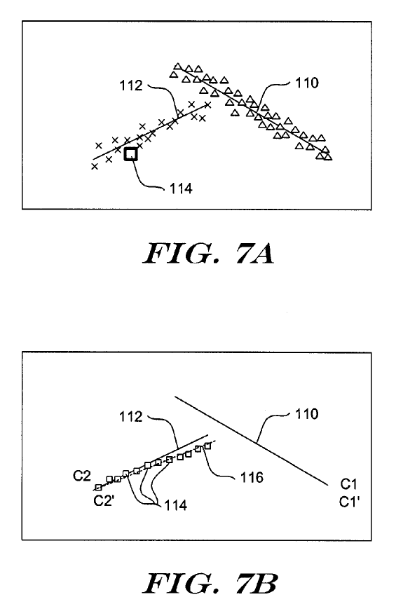

FIGS. 7A-7B illustrate observation of a new data point and updating of a multiple model regression in light of a plurality of data points. In the illustrative embodiment, the past data (which may be testing and/or training data) has been characterized by first function 110 and second function 112. At this point, the method/device operates in a predictive mode, and has finished the initial learning and testing steps discussed with reference to FIG. 2. Data is captured by the device and a new data point 114 is shown in relation to the functions 110, 112.

In an illustrative example, when the new data point 114 is captured, it may then be associated with one of the available models. The step of associating new data with an existing model may include, for example, a determination of the nearest model to the new data. If the new data is not “close” to one of the existing models, it may be marked as aberrant, for example. “Close” may be determined, for example, by the use of a number of standard deviations.

If it is determined that the new data 114 should be associated with one of the existing models, several steps may follow. In some embodiments, the association of new data 114 with one of the multiple models may be used to inform a predictive step. For example, rather than considering each of several models in making a prediction of future performance, only the model associated with the new data 114 may be used.

FIG. 7B illustrates two additional steps that may follow a determination that new data 114 is associated with one or the other of the available models 110, 112. As shown in FIG. 7B, first model 110 has an initial weight C1, and second model 112 has an initial weight C2. When new data is captured and associated with one or the other of the models 110, 112, new weights C1′ and C2′ may be calculated. In an illustrative example, the weights may be adaptive over time. Adaptive calculation of the weights C1, C2, C1′, C2′ may include a first-in, first-out calculation where only the last N samples are used to provide weights.

Another adaptive step may include the changing of the second function 112. As shown, several new data points 114 are captured and lie along a line that is close to, but are consistently different from the second function 112. Given the new data points 114, the second function 112 may be modified to reflect the new data, yielding a new second function 116.

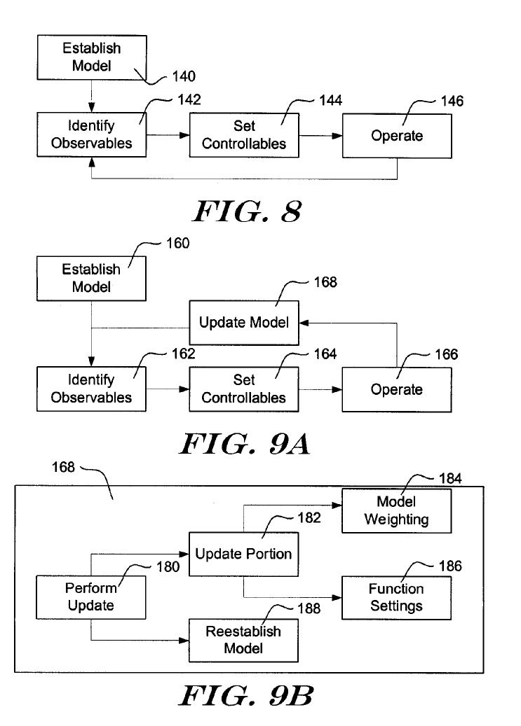

FIG. 8 shows in block form an illustrative method. As shown in FIG. 8, a first step is to establish the model, which may be a multiple model regression, as shown at 140. Next, the method identifies observable values, as shown at 142, either for an individual node or across several devices that make up a system. Using the model and the observables, one or more controllable factors are set, as shown at 144. The step of setting a controllable factor may include changing the controllable factor or leaving the controllable factor at the same state or variable as it was previously. The method then includes allowing operations to occur, as shown at 146. The method then iterates back to identifying observable values at 142.

FIGS. 9A and 9B show, in block form, another illustrative method. Referring to FIG. 9A, in this example, the model is established at 160. Observables are identified, as shown at 162, controllables are set as shown at 164, and the method allows operations to occur, as shown at 166. To this point, the method is not unlike that of FIG. 8. Next, however, the model may be updated, as shown at 168, prior to returning to step 162.

FIG. 9B highlights several ways in which the model can be updated. From block 180, there are two general manners of performing an update. A portion of the model may be updated, as indicated at 182. This may include adjusting the model weights, as shown at 184. Updating a portion 182 may also include modifying the function values, as shown at 186. In some embodiments, rather than updating a portion of the model 182, the method may instead seek to reestablish the set of models, as shown at 188. Reestablishment 188 may occur periodically or occasionally, depending upon system needs. The step of reestablishing the model 188 may be performed by invoking a learning routine, and/or by the use of training, test, and/or operating data.

In some embodiments, a determination may be made regarding whether to update the model. For example, data analysis may be performed on at least selected observable data to determine whether one of the identified multiple models is being followed over time. If it is found that there is consistent, non-zero-mean error, then one or more of the models may need refinement. If, instead, there are consistent observable data that do not correspond to any of the identified models, a reestablishment of the model may be in order.

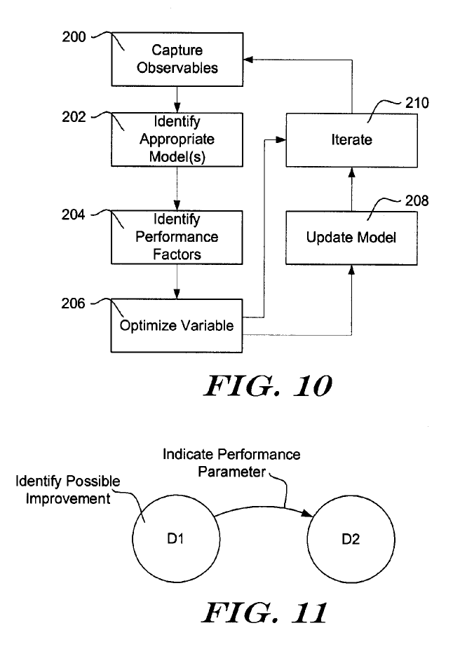

FIG. 10 shows in block form yet another illustrative method. In this method, an established multiple model estimation is presumed. The method begins by capturing observables, as shown at 200. Next, from the observables, the appropriate model is identified, as shown at 202, from among those which have been selected for the established multiple model estimation. Using this appropriate model, performance factors may be identified, as shown at 204. The performance factors may be controllable variables that affect the performance outcome. Next, as shown at 206, optimization is performed to improve performance. The optimization may include modifying a controllable variable (hence, a controllable aspect of the device or system) in a manner that, according to the model, is predicted to improve system performance.

After optimization, the method may either continue to update the model as shown at 208, either on an ongoing basis or as necessitated by incoming data that suggest modification is needed. Otherwise, if no updating is performed, or after updating, the method continues to iterate itself, as shown at 210. The iteration may occur on an ongoing basis, for example, where iteration occurs as soon as computation is complete. In some embodiments, rather than the ongoing basis, iteration 210 may include setting a timer and waiting for a predetermined time period to perform the next operation. For example, in a given node, it may be desirable to avoid instability that the optimization only occurs periodically, for example, every 30 seconds. Alternatively, optimization may occur occasionally, as, for example, when a message is received that indicates optimization should occur, or when a timer or counter indicates optimization should occur. For example, if a counter indicating data transmission errors passes a threshold level within a certain period of time, optimization may be in order.

As can be seen from the above, there are many different types and levels of analysis that may be performed. In some illustrative MANET embodiments, different nodes are differently equipped for analysis. In particular, some nodes may be equipped only to receive instructions regarding operation, while other nodes may be equipped to perform at least some levels of analysis, such as updating portions of a model and determining whether the multiple model solutions that are initially identified are functioning. Yet additional nodes may be equipped to perform analysis related to establishing a model. Such nodes may be differently equipped insofar as certain nodes may include additional or different programming and/or hardware relative to other nodes.

FIG. 11 shows another illustrative embodiment in which a first device indicates an operating parameter to second device. In the illustrative embodiment, the first device D1 analyzes its own operation and determines that, given its operating environment/conditions, a change in operation by a second device D2 may provide for improvement. An example may be if device D1 is experiencing received transmission errors on a consistent basis. One solution may be for device D2 to reduce its data transmission length to accommodate the problems experienced by D1. While the data manipulations at D1 that would correspond to this circumstance may not provide such a qualitative description, the result is the same. Specifically, D1, having identified a potential manner of improving system and device operation, communicates a suggested operating parameter to D2. If the suggested operating parameter can be efficiently incorporated by D2, D2 will do so. For example, D2 may incorporate the operating parameter into only the communications it addresses to D1, or into all communications. If desired, D1 may further address the improvements to a particular node other than D2, and D2 may in turn pass on the message.

While the above discussion primarily focuses on the use of the present invention in MANET embodiments, the methods discussed herein may also be used in association with other wireless networks and other communication networks in general.

Those skilled in the art will recognize that the present invention may be manifested in a variety of forms other than the specific embodiments described and contemplated herein. Accordingly, departures in form and detail may be made without departing from the scope and spirit of the present invention as described in the appended claims.

What is claimed is:

1. A method of estimating an operation parameter of a device in an ad-hoc network comprising:
gathering a collection of training data generated by operation or simulation of an ad-hoc network;
identifying a first model of operation for a first subset of the training data; and
identifying a second model of operation for a second subset of the training data.

2. The method of claim 1 further comprising:
determining a first weight factor for the first model of operation;
determining a second weight factor for the second model of operation;
wherein determination of the first weight factor and determination of the second weight factor each include, at least in part, consideration of the sizes of the first and second subsets.

3. The method of claim 2 further comprising:
observing an operation of an ad-hoc network device to capture a set of observables associated with a first measurement sample;
characterizing the first measurement sample as being associated with one of the first model of operation or the second model of operation; and
modifying at least one of the first weight value or the second weight value.

4. The method of claim 1 further comprising:
observing operation of an ad-hoc network to capture a set of observable operating variables;
updating at least one of the first model of operation or the second model of operation in light of the set of observable operating variables.

5. A method of operating a mobile ad-hoc network comprising:
capturing a set of data related to a current state of a mobile ad-hoc network;
estimating an operation parameter of the mobile ad-hoc network using a model generated in accordance with claim 1;
optimizing at least a first controllable variable for the mobile ad-hoc network.

6. A method of operating a mobile ad-hoc network comprising:
capturing a set of data related to a current state of a device in the mobile ad-hoc network;
identifying a correspondence between the current state of the device and a model generated in accordance with claim 1; and
optimizing operation of the device by modifying a controllable variable for the device.

7. The method of claim 1 further comprising:
after identifying the first model of operation, partitioning the training data into the first subset and a remainder; wherein
the step of identifying the second model of operation includes considering only training data in the remainder.

8. The method of claim 1 further comprising identifying first and second weight functions, each weight function varying in relation to a component common to the first and second models of operation.

9. A device configured and equipped for operation in a mobile ad-hoc network comprising at least a controller and wireless communications components, the controller configured to estimate operation of the device by the use of a multiple model estimation technique developed in accordance with claim 1.

10. A device configured and equipped for operation in a mobile ad-hoc network, the device comprising:
a controller; and
wireless communication components operatively coupled to the controller;
wherein the controller is adapted to perform the steps of:
capturing data related to one or more observable parameters of the device; and
estimating a future performance parameter for the device by analysis of the captured data using a multiple model estimation.

11. The device of claim 10 wherein the multiple model estimation technique includes the following:
an identified first model;
an identified second model;
a first weight factor; and
a second weight factor;
wherein the first weight factor is associated with the first model and the second weight factor is associated with the second model.

12. The device of claim 11 wherein:
the first model is associated with a first set of data taken from a training data set;
the second model is associated with a second set of data taken from the training data set;
the first weight factor is proportional to the share of the training data set that comprises the first set; and
the second weight factor is proportional to the share of the training data set that comprises the second set.

13. The device of claim 11 wherein the first and second weight factors vary in relation to an observable parameter.

14. The device of claim 11 wherein the controller is further adapted to perform the steps of:
identifying a first data element comprising one or more of the observable parameters as measured at a given time;
determining whether the first data element is associated with a model from the multiple model estimation; and
if the first data element is associated with one of the first model or the second model, modifying one of the first model, the second model, the first weight factor, or the second weight factor.

15. A mobile ad-hoc network comprising at least one device as in claim 11.

16. A mobile ad-hoc network comprising at least one device as in claim 10.

17. The device of claim 10 wherein the controller is further adapted to adjust an operating parameter of the device to improve the future performance parameter.

18. The device of claim 10 wherein the controller is further adapted to communicate with another device in an ad-hoc system to cause the another device to adjust an operating parameter to improve the future performance parameter.
